(19) United States
(12) Patent Application Publication
(10) Pub. No.: US 2024/0307722 A1
(43) Pub. Date: Sep. 19, 2024

(54) COMPOSITE ADHESIVE FIRE BARRIER AND METHOD OF MAKING AND USING THE SAME

(71) Applicant: 3M INNOVATIVE PROPERTIES COMPANY, St. Paul, MN (US)

(72) Inventors: Junkang J. Liu, Woodbury, MN (US); Scott R. Meyer, Woodbury, MN (US)

(21) Appl. No.: 18/575,968

(22) PCT Filed: Jul. 18, 2022
(86) PCT No.: PCT/IB22/56606

§ 371 Date: Jan. 2, 2024

Related U.S. Application Data
(60) Provisional application No. 63/224,654, filed on Jul. 22, 2021.

(51) Int. Cl. A62C 3/16; A62C 3/06; C08K 3/34; C09J 7/38; C09J 183/04

(52) U.S. Cl. CPC A62C 3/16; A62C 3/06; C08K 3/34; C09J 7/38; C09J 183/04

(57) ABSTRACT

A composite adhesive fire barrier comprises a fire barrier material having first and second opposed major surfaces and a pressure-sensitive adhesive layer disposed on the first major surface of the fire barrier material. The fire barrier material comprises inorganic fibers and has an inorganic component content of at least 50 percent by weight. The pressure-sensitive adhesive layer comprises a crosslinked mixture of a silicone having a kinematic viscosity of at least 30,000 centistokes and an MQ silicate tackifying resin disposed on the fire barrier material. The silicone and the MQ silicate tackifying resin are present in a respective weight ratio of 4:1 to 20:1. A release liner comprising a fluorinated compound is releasably adhered to the pressure-sensitive adhesive layer. Methods of making and using the composite adhesive fire barrier are also disclosed.

### TECHNICAL FIELD

The present disclosure broadly relates to fire barriers, methods of making them, and methods of using them.

### BACKGROUND

Rechargeable batteries and rechargeable electrical energy storage systems comprising a number of single battery cells, such as for example lithium-ion cells, are known and commonly used in several fields of technique, including, e.g., as electric power supplies of mobile phones and portable computers or electric cars or vehicles or hybrid cars.

Rechargeable battery cells, such as lithium-ion cells, sometimes undergo internal overheating caused by events such as short circuits within the cell, improper cell use, manufacturing defects or exposure to extreme external temperature. This internal overheating can lead to a so called “thermal runaway” when the reaction rate within the cell caused by the high temperature increases to a point where more heat is generated within the cell than can be withdrawn and the generated heat leads to a further increase of the reaction rate and heat generated. In lithium-ion (Li ion) batteries, for example, the heat generated within such defective cells can reach 500° C. to 1000° C., and in localized hot spots even more.

In particular, it is important in such catastrophic cases to prevent fire/flame spreading or at least interrupt/reduce a heat transfer from defective cells or cell packs to other parts of the storage system or around the storage system, because the heat/flame generated in a defective battery cell or cell pack can spread out to the neighboring cells, which in tum can cause overheat and then undergo thermal runaway. It is also important to limit the heat transfer to parts around the storage system, which may be destroyed or harmed when heated at the abovementioned temperatures, causing electrical shortages which in tum could lead to unwanted effects as further cells getting into a thermal runaway.

It is known to provide safety precautions for protecting the environment of overheated battery cells or packs of battery cells against the generated heat, including, in particular, not yet affected battery cells or packs but also surrounding construction elements of the system or device or apparatus containing the battery cells. One such precaution is insertion of thermally insulating barrier elements inside of a storage system in order to prevent or reduce the heat transfer from an overheated battery cell or pack of battery cells to other battery cells or cell packs of batteries and/or to the environment of the storage system.

PCT publication WO 2021/022130A1 (Huang et al.) describes a multilayer material for use as a thermal insulation barrier and/or flame barrier in a rechargeable electrical energy storage system. The multilayer material comprises at least one inorganic fabric layer bonded to a nonwoven layer comprising inorganic particles and inorganic fibers by a bonding adhesive. The bonding adhesive can be a modified bonding adhesive comprising at least 99 wt. % inorganic constituents and an organic additive of at least 0.01 wt. % and less than 1 wt. % based on a total solids content of the bonding adhesive. The multilayer material can be secured between the at least one battery cell or module and a lid of the storage system by an adhesive, mechanical fasteners, or a combination thereof. Exemplary adhesives for attaching the multilayer materials to the lid may include a flame retardant version of a transfer adhesive or a double-coated adhesive tape.

### SUMMARY

The afore-mentioned adhesives are typically hydrocarbon adhesives coated out of an organic solvent, which burns to carbon dioxide gas, loses adhesive holding power, and may drip or flow to promote fire spreading and/or explosion during a thermal runaway event. The present disclosure overcomes this problem by using a silicone pressure-sensitive adhesive (psa) layer that can be made by a solvent-five process and use electron beam (e-beam) crosslinking technology.

To make and store the psa-coated composite fire barriers according to the present disclosure it is normally desirable to protect the adhesive surface with a release liner. However, typical release liners utilizing release materials containing silicone segments (e.g., fluorosilicones) do not have sufficient adhesive release properties or aging stabilities when used with the silicone-based pressure-sensitive adhesive layers used in the present disclosure, and may result in damage to other components of the composite fire barrier during removal of the release liner prior to use. Advantageously, the present disclosure overcomes that problem as well by using certain other fluorinated release liners free of silicone moieties.

In one aspect, the present disclosure provides a composite adhesive fire barrier comprising:
a fire barrier material having first and second opposed major surfaces, the fire barrier material comprising inorganic fibers and having an inorganic component content of at least 50 percent by weight;
a pressure-sensitive adhesive layer disposed on the first major surface of the fire barrier material, wherein the pressure-sensitive adhesive layer comprises a crosslinked mixture of a silicone having a kinematic viscosity of at least 30,000 square millimeters per second (30000 cSt) and an MQ silicate tackifying resin disposed on the fire barrier material, wherein the silicone and the MQ silicate tackifying resin are present in a respective weight ratio of 1:2 to 20:1; and
a release liner comprising a fluorinated compound, wherein the release liner is free of silicone moieties, and wherein the pressure-sensitive adhesive layer is releasably adhered to the release liner.

In another aspect, the present disclosure provides a method of making a composite adhesive fire barrier, the method comprising:
providing a fire barrier material having first and second opposed major surfaces, the fire barrier material comprising inorganic fibers and having an inorganic component content of at least 50 percent by weight;
extruding a mixture onto the first major surface of the fire barrier material, wherein the mixture comprises a silicone having a kinematic viscosity of at least 30,000 centistokes and an MQ silicate tackifying resin disposed on the fire barrier material, wherein the silicone and the MQ silicate tackifying resin are present in a respective weight ratio of 1:2 to 20:1;
crosslinking the mixture by exposing it to electron beam radiation to provide a pressure-sensitive adhesive layer; and
releasably adhering a release liner to the pressure-sensitive adhesive layer, wherein the release liner comprises a fluorinated compound, and wherein the release liner is free of silicone moieties.

In yet another aspect, the present disclosure provides a method of using a composite adhesive fire barrier according to the present disclosure, the method comprising:
separating the release liner from the pressure-sensitive adhesive layer; and
adhering the pressure-sensitive adhesive layer to at least one component of an electrical battery pack.

As used herein:
the term “adherends” refers to two bodies bonded together by an adhesive layer;
the term “fluorosilicone” refers to a silicone having one or more C—F bonds;
the term “intumescent” means irreversibly expandable by heating;
the term “silicone” refers to any of a class of synthetic materials which are polymers with a chemical structure based on chains of alternate silicon and oxygen atoms, and having organic groups attached to the silicon atoms;
the term “releasably adhered” means that the adherends can be cleanly peeled apart by hand without physically damaging them, however curling of the adherends is acceptable;
the term “silicone moieties” refers to polysiloxane segments comprising an Si—O—Si—O—Si bond sequence;
the term “organic solvent” refers to an organic liquid, other than a reactant, typically added to dissolve one or more organic compounds and/or reduce viscosity; and
the term “volatile organic solvent” refers to any organic solvent that readily evaporates at 1 atmosphere of pressure and 20 degrees Celsius.

Features and advantages of the present disclosure will be further understood upon consideration of the detailed description as well as the appended claims

### BRIEF DESCRIPTION OF THE DRAWINGS

FIG. 1 is a schematic side view of an exemplary composite fire barrier 100 according to one embodiment of the present disclosure.

FIG. 2 is a schematic side view of an exemplary composite fire barrier 200 according to one embodiment of the present disclosure.

FIG. 3 is a schematic side view of an exemplary composite fire barrier 300 according to one embodiment of the present disclosure.

FIG. 4 is a schematic side view of an exemplary composite fire barrier 400 according to one embodiment of the present disclosure.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

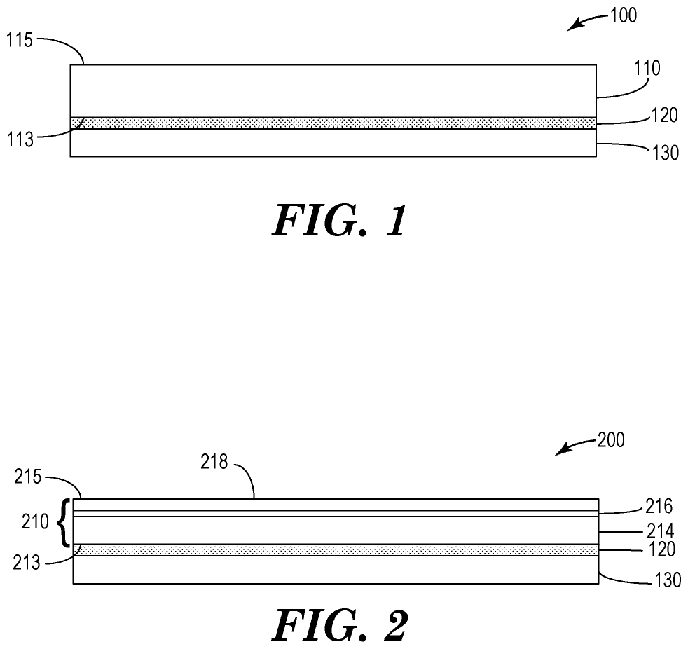

Referring now to FIG. 1, composite adhesive fire barrier 100 comprises fire barrier material 110 having first and second opposed major surfaces (113, 115), pressure-sensitive adhesive layer 120 disposed on first major surface 113 of fire barrier material 110, and release liner 130 releasably adhered to pressure-sensitive adhesive layer 120.

The fire barrier material comprises inorganic fibers and optionally: inorganic filler (including intumescent inorganic filler), flame retardant, and a binder.

Suitable inorganic fibers include, for example, glass fibers, ceramic fibers, glass-ceramic fibers, and combinations thereof.

Exemplary glass fibers comprise aluminoborosilicate glass, alkali lime glass with little or no boron content (e.g., A-glass), alumino-lime silicate glass (e.g., E-CR-glass), alkali-lime glass with high boron oxide content (e.g., C-glass), borosilicate glass (D-glass), aluminosilicate glass (e.g., R-glass), and aluminosilicate glass (e.g., S-glass).

Exemplary inorganic ceramic fibers may comprise zirconia, zirconia-alumina, zirconia-calcia, alumina, magnesium aluminate, mullites, and aluminoborosilicates (glass-ceramic). Such fibers additionally can contain various metal oxides such as, e.g., iron oxide, chromic, and cobalt oxide.

In some embodiments, the inorganic fibers comprise aluminum oxide in the range from about 60 to about 98 percent by weight and silicon oxide in the range from about 40 to about 2 percent by weight. These fibers are commercially available, for example, as NEXTEL 550 from the 3M Company, St. Paul, Minnesota, SAFFIL from Dyson Group PLC, Sheffield, United Kingdom, MAFTEC from Mitsubishi Chemical Corp., Tokyo, Japan, FIBERMAX from Unifrax, Niagara Falls, New York, and ALTRA from Rath GmbH, Germany. Suitable polycrystalline oxide ceramic fibers further include aluminoborosilicate fibers preferably comprising aluminum oxide in the range from about 55 to about 75 percent by weight, silicon oxide in the range from less than about 45 to greater than zero (preferably, less than 44 to greater than zero) percent by weight, and boron oxide in the range from less than 25 to greater than zero (preferably, about 1 to about 5) percent by weight (calculated on a theoretical oxide basis as Al₂O₃, SiO₂, and B₂O₃, respectively).

Melt-formed refractory ceramic inorganic fibers are also available from a number of commercial sources and include these known under the trade designations: FIBERFRAX from Unifrax, Tonawanda, New York; KAOWOOL from Thermal Ceramics Co., Augusta, Georgia; CER-WOOL from Premier Refractories Co., Erwin, Tennessee; CERAFIBER from Morgan Advanced Materials, Windsor, United Kingdom; and SNSC from Shin-Nippon Steel Chemical, Tokyo, Japan.

The inorganic fibers may comprise heat-treated ceramic inorganic fibers sometimes called annealed ceramic fibers. Annealed ceramic fibers may be obtained as disclosed in U.S. Pat. No. 5,250,269 (Langer) or PCT publication WO 99/46028 A1 (Fernando et al.).

The inorganic fibers may be continuous tow and/or chopped (staple) fibers and may have any average diameter; in some embodiments, between 1 micrometer and 16 micrometers, for example.

Optional inorganic fillers includes magnesium hydroxide, alumina trihydrate, nesquehonite, hydromagnesite, sodium dawsonite, magnesium carbonate subhydmte, boehmite, magnesium phosphate octahydrate, gypsum, and intumescent inorganic fillers such as micaceous minerals such as unexpanded vermiculite ore, treated unexpanded vermiculite ore, partially dehydrated vermiculite ore (collectively mica), processed expandable sodium silicate, for example, that is commercially available under the trade designation EXPANTROL (insoluble sodium silicate) from 3M Company, and mixtures thereof.

Optional binder may be organic or inorganic. Examples of organic binders include acrylic binders and polyurethane binders. Examples of inorganic binders include alkali metal silicates. If optional organic binder is present, it is present in an amount of less than 15 percent by weight, less than 10 percent by weight, less than 5 percent by weight, or less than 1 percent by weight, based on the total weight of the fire barrier material.

The fire barrier material may have an inorganic component(s) content of at least 50 percent by weight, at least 60 percent by weight, at least 70 percent by weight, at least 80 percent by weight, at least 90 percent by weight, at least 95 percent by weight, at least 98 at least 98 percent by weight, at least 99 percent by weight, or even 100 percent by weight.

The fire barrier material is generally a substantially two-dimensional material (e.g., a sheet or web) which may have any thickness, and which may be uniform or nonuniform. Often, the fire barrier material has a thickness of 0.01 to 5 millimeters (mm), preferably 0.5 to 3 mm.

The total thickness of the composite adhesive fire barrier may be between 0.5 and 23 mm. In some applications where thinner materials are used, the total thickness of the multilayer material between 0.7 and 5 mm. In some embodiments, the multilayer material will have a total thickness less than 3 mm, preferably less than 2 mm. It is possible to adjust the thickness of the composite adhesive fire barrier depending on the application where it is used. The composite adhesive fire barrier may be flexible to improve the ease of applying it in an assembly process. The composite adhesive fire barrier may also be compressible in order to improve the ease of applying it in an assembly process.

The pressure-sensitive adhesive layer comprises a crosslinked mixture of a silicone and a silicate tackifying resin. The silicone may be a fluid or a gum at 25° C. The silicone may have a kinematic viscosity of at least 30000 mm²/sec (30000 cSt) and a silicate tackifying resin (MQSTR). Typically, the silicone and the MQ silicate tackifying resin are present in a respective weight ratio of 1:2 to 20:1; in some embodiments 4:1 to 20:1.

In some embodiments, the silicone has a kinematic viscosity of at least 100000 mm²/sec (100000 cSt), at least 300000 mm²/sec (300000 cSt), at least 500000 mm²/sec (500000 cSt), at least 700000 mm²/sec (700000 cSt), or even at least at least 900000 mm²/sec (900000 cSt). Kinematic viscosity of silicone fluids can be determined according to ASTM D4283-98 (Reapproved 2015), “Standard Test Method for Viscosity of Silicone Fluids”. As used herein, silicone fluids have a kinematic viscosity at 25° C. of less than 10 6 mm²/sec (i.e., <1000000 cSt) and silicone gums have a kinematic viscosity at 25° C. of at least 10 6 mm²/sec (10 6 cSt).

Generally, silicones useful in the present disclosure are polysiloxanes (i.e., materials comprising a polysiloxane backbone). The silicones are linear polymers material described by Formula (I), below:

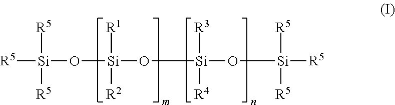

wherein R¹, R², R³, and R⁴ are independently selected from the group consisting of an alkyl group (e.g., a methyl, ethyl, or propyl group) and an aryl group (e.g., a phenyl group), each R⁵ is an alkyl group and m and n are integers ≥0, and at least one of m or n is not zero.

In some embodiments, R⁵ is a methyl group (i.e., the nonfunctionalized polysiloxane material is terminated by trimethylsiloxy groups). In some embodiments, R¹ and R² are alkyl groups and n=0 (i.e., the material is a poly(dialkylsiloxane)). In some embodiments, the alkyl group is a methyl group, i.e., poly(dimethylsiloxane) (PDMS). In some embodiments, R¹ is an alkyl group, R² is an aryl group, and n=0 (i.e., the material is a poly(alkylarylsiloxane)). In some embodiments, R¹ is a methyl group, R² is a phenyl group, and n=0 (i.e., the material is poly(methylphenylsiloxane)). In some embodiments, R¹ and R² are alkyl groups, R³ and R⁴ are aryl groups, and m, n>0 (i.e., the material is a poly(dialkyldiarylsiloxane)). In some embodiments, R¹ and R² are methyl groups, R³ and R⁴ are phenyl groups, and m, n>0 (i.e., the material is poly(dimethyldiphenylsiloxane).

MQ silicate tackifying resins are cage like molecules having a shell of R′₃SIO_{1/2} units (“M” units) around SiO_{4/2} units (“Q” units) in a core, where the M units are bonded to the Q units, each of which is bonded to one Q unit. Some of the SiO_{4/2} units (“Q” units) are bonded to hydroxyl groups resulting in HOSiO_{3/2} units (“T^{OH}” units), thereby accounting for the silicon-bonded hydroxyl content of the siloxane tackifying resin, and some are bonded only to other SiO_{4/2} units. These siloxane tackifying resins usually have a number average molecular weight in the range of 100 to 50,000 grams/mole or in the range of 500 to 15,000 grams per mole and generally have methyl R′ groups.

MQ silicate tackifying resins are described in, for example, Encyclopedia of Polymer Science and Engineering, vol. 15, John Wiley & Sons, New York, (1989), pp. 265-270, and U.S. Pat. No. 2,676,182 (Daudt et al.), U.S. Pat. No. 3,627,851 (Brady), U.S. Pat. No. 3,772,247 (Flannigan), and U.S. Pat. No. 5,248,739 (Schmidt et al.). Other examples are disclosed in U.S. Pat. No. 5,082,706 (Tangney). The above-described resins are generally prepared in solvent. Dried or solventless, MQ siloxane tackifying resins can be prepared, as described in U.S. Pat. No. 5,319,040 (Wengrovius et al.), U.S. Pat. No. 5,302,685 (Tsumura et al.), and U.S. Pat. No. 4,935,484 (Wolfgruber et al.).

Certain MQ silicate tackifying resins can be prepared by the silica hydrosol capping process described in U.S. Pat. No. 2,676,182 (Daudt et al.) as modified according to U.S. Pat. No. 3,627,851

(Brady), and U.S. Pat. No. 3,772,247 (Flannigan) These modified processes often include limiting the concentration of the sodium silicate solution, and/or the silicon-to-sodium ratio in the sodium silicate, and/or the time before capping the neutralized sodium silicate solution to generally lower values than those disclosed by Daudt et al. The neutralized silica hydrosol is often stabilized with an alcohol, such as 2-propanol, and capped with R₃SiP_{1/2} siloxane units as soon as possible after being neutralized, wherein

R represents an alkyl group. The level of silicon bonded hydroxyl groups (i.e., silanol) on the MQ resin may be reduced to no greater than 1.5 weight percent, no greater than 1.2 weight percent, no greater than 1.0 weight percent, or no greater than 0.8 weight percent based on the weight of the siloxane tackifying resin. This may be accomplished, for example, by reacting hexamethyldisilazane with the siloxane tackifying resin. Such a reaction may be catalyzed, for example, with trifluoroacetic acid. Alternatively, trimethylchlorosilane or trimethylsilylacetamide may be reacted with the siloxane tackifying resin, a catalyst not being necessary in this case.

Suitable MQ silicate tackifying resins are commercially available from sources such as Dow Corning, Momentive Performance Materials, Bluestar Silicones, NuSil, and Wacker Silicones. Examples of useful MQ silicate tackifying resins include those available under the trade designations SR-545 and SR-1000, both of which are commercially available from Momentive Performance Materials, PRO-2780 available from NuSil, and TMS-803 available from Wacker Silicones. Such resins are generally supplied in organic solvent and may be employed as received, or they may be diluted. In some embodiments, it may be desirable to utilize the silicate tackifying resin as a solid, so the resin solution may be dried to form solid or, in some embodiments, the silicate resin may be obtained as a solid powder.

When the MQ silicate tackifying resins are used as a solution, typically the resin solutions are further diluted from the concentration in which they are obtained. In some embodiments, the 100% solid of silicate tackifying resin solutions are used as powders or flakes and fed into a twin screw extruder.

The silicone may be combined with the MQ silicate tackifying resin and chemically crosslinked. Typically, the weight ratio of silicone to MQ STR is 30:70 to 90:10, preferably 40:60 to 80:20, although other ratios may also be used.

In some embodiments, the silicone and MQ silicate tackifying resin are mixed by a twin screw extruder, wherein the twin screw extruder has multiple ports for raw material feedings. Preferably silicone and MQ silicate tackifying resin are fed into a twin screw extruder from different ports. Optionally at least one port is connected to vacuum pump to devolatilize low molecule weight silicones.

In some embodiments, additional additives can be added in the adhesive mixing step, including but not limited to: inorganic fillers (e.g., silicate, aluminosilicate, calcite, clay, carbon black, carbon nanotubes, inorganic fibers, and pigments).

In some embodiments, the silicone/MQ silicate tackifying resin mixture is coated directly on to multilayer fire barrier through a die (e.g., a rotary rod die, slot die, or drop die). Subsequently, the resin mixture is irradiated with an electron beam (i.e., e-beam) to provide a crosslinked silicone pressure-sensitive adhesive. In some embodiments, resin mixture compounding, coating, and curing are carried out sequentially as a continuous process. The e-beam cured silicone adhesive fire barrier can be laminated to a release liner. The lamination may be operated in the continuous process described above, or it may be carried out independently.

Elevated temperatures in multiple zones of twin screw extruder can be used to reduce the viscosity of mixtures. If desired, a small amount of organic solvent (e.g., one or more hydrocarbon solvents) may be added to further reduce viscosity. Crosslinking is preferably accomplished by exposure to electron beam (e-beam) radiation. Advantageously, e-beam radiation can be used without need of added catalysts and/or initiators (i.e., they mixture may be free of catalysts and/or initiators).

A variety of procedures for E-beam curing are well-known. The cure depends on the specific equipment used to deliver the electron beam, and those skilled in the art can define a dose calibration model for the equipment used. Commercially available electron beam generating equipment is readily available. For the examples described herein, the radiation processing was performed on a Model CB-300 electron beam generating apparatus (available from Energy Sciences, Inc., Wilmington, Massachusetts. Generally, a support film (e.g., polyester terephthalate support film) runs through an inert chamber. In some embodiments, a sample of adhesive coated fire barrier is covered by a release liner prior to e-beam radiation (e.g., as described herein “closed face” radiation) and conveyed at a fixed speed of about 6.1 meters/min (20 feet/min). In some embodiments, a sample of adhesive coated fire barrier is radiated with e-beam before laminated to a release liner(“open face” radiation).

The crosslink density is generally affected by the dose of e-beam radiation applied. The higher e-beam dose, the higher the crosslinking density. The e-beam source voltage will typically depend on the thickness of the coated mixture to have high enough radiation penetration. Selection of appropriate conditions is within the capability of those skilled in the art. Further details concerning preparation of crosslinked silicone pressure-sensitive adhesives is described in U.S. Pat. No. 9,359,529 (Liu et al), the disclosure of which is incorporated herein by reference.

The fire barrier material may be unitary or have a composite structure (e.g., a layered composite structure), for example. Referring now to FIG. 2, composite adhesive fire barrier 200 comprises fire barrier material 210 (i.e., a composite fire barrier material) having first and second opposed major surfaces (213, 215). Fire barrier material 210 comprises insulating paper 214 comprising inorganic fibers. Woven glass fabric 218 is secured to insulating paper 214 by bonding adhesive 216. Pressure-sensitive adhesive layer 120 is disposed on first major surface 213 of fire barrier material 210, and release liner 130 releasably adhered to pressure-sensitive adhesive layer 120.

Useful inorganic insulating papers may include glass fibers, ceramic fibers, inorganic particles, and an inorganic or organic binder (typically in a minor amount of less than 10 weight percent, preferably less than 1 weight percent). Generally, the insulating paper is at least 60 weight percent, at least 70 weight percent, at least 80 weight percent, or even at least 90 weight percent inorganic. One useful insulating paper is marketed under the trade designation 3M CeQUIN Inorganic Insulating Paper from 3M Company, St. Paul, Minnesota in grades 3MCeQUIN I, 3M CeQUIN II and 3M CeQUIN 3000. These inorganic insulating papers are commercially available in various thicknesses ranging from 5 to 30 mil (0.13 mm to 0.76 mm).

In order to strengthen the inorganic insulating paper, a bonding adhesive may bond the inorganic insulating paper to a woven inorganic fabric. Preferably, the bonding adhesive layer has an inorganic solids content of at least 50 weight percent, at least 60 weight percent, at least 70 weight percent, at least eighty weight percent, at least 90 weight percent, at least 99 weight percent, or even 100 percent. Exemplary bonding adhesives include alkali metal silicates (e.g., lithium silicate, sodium silicate, potassium silicate), typically used as a solution in water. The bonding adhesive may comprise organic adhesive/binder (e.g., acrylic polymer, polyurethane), although it is generally desirable to keep the content of combustible organic materials at a low level (e.g., less than 5 weight percent of solids). The bonding adhesive may be used in any suitable thickness, which may depend on the specific insulating paper and woven inorganic fabric used.

Suitable woven inorganic fabric may be made from inorganic fibers such as E-glass fibers, R-glass fibers, ECR-glass fibers, C-glass fibers, AR-glass fibers, basalt fibers, ceramic fibers, silicate fibers, steel filaments, or a combination thereof. The fibers may be chemically-treated. The woven inorganic fabric can improve the increased tensile strength, tear strength, and elongation to the multilayer composite, which can be helpful for industrial manufacturing and converting processes as well as protecting the other layers in the multilayer material from the thermal and mechanical impact during a thermal runaway event.

The woven inorganic fabric may for example comprise a thickness in the range of 0.3 to 3 mm, for example 0.4 to 1.5 mm, or 0.4 to 1 mm. The inorganic fabric may also comprise a basis weight of above 400 g/m² (gsm). The exemplary inorganic fabric can have a basis weight from 400 gsm to 6100 gsm. In some embodiments, the exemplary inorganic fabric will have a basis weight between 400 gsm to 30 1000 gsm.

In some embodiments, a surface finish or surface coating can be applied to the inorganic fabric, especially glass fiber fabrics, to enhance high temperature resistant to up to 700° C. or for short bursts up to 750° C. Exemplary surface coatings include calcium silicate, vermiculite, or a silica sol to enhance high temperature resistance and/or abrasion resistance of the inorganic fiber.

A release liner may be releasably adhered to the pressure-sensitive adhesive layer to protect it during storage and shipping. Useful release liners comprise a fluorinated compound, but are free of silicone moieties (e.g., as in poly(dimethylsiloxane) or a fluorosilicone),

In some embodiments, the release liner can be unitary. One such embodiments is an extruded film comprising a non-fluorinated thermoplastic and a fluorinated melt additive as described in U.S. Patent Application Publication No. 2020/0207948 (Teverovskiy), the disclosure of which is incorporate herein by reference.

Exemplary fluorinated melt additives according to the present disclosure are represented by general formula I, below:

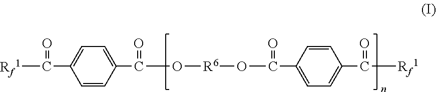

R⁶ represents a linear alkylene group having from 1 to 18 carbon atoms, preferably from 2 to 12 carbon atoms, and more preferably from 2 to 8 carbon atoms, and even more preferably 2 to 6 carbon atoms. Exemplary groups R⁶ include ethylene, propane-1,3-diyl, butane-1,4-diyl, pentane-1,5-diyl, hexane-1,6-diyl, octane-1,8-diyl, decane-1,10-diyl, dodecane-1,12-diyl, hexadecane-1,16-diyl, and octadecane-1,18-diyl.

n represents an integer from 1 to 4, inclusive (i.e., n=1, 2, 3, or 4).

R_{f}¹ represents a monovalent group represented by the general formula

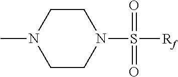

wherein R_{f} represents a perfluorinated group having from 3 to 5 carbon atoms, preferably R_{f} has 4 carbon atoms. Examples of groups R_{f} include perfluoro-n-pentyl, perfluoro-n-butyl, perfluoro-n-propyl, perfluoroisopropyl, and perfluoroisobutyl.

Compounds according to general formula I can be made by any suitable method. One relatively convenient method involves reaction of one acyl chloride group from each of two terephthaloyl chloride molecules with a diol to create an extended diacyl chloride, which is then reacted with two equivalents of a fluorinated piperazine represented by the general formula II, below:

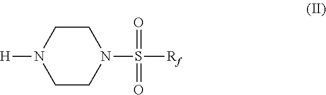

to form the corresponding melt additive compound; for example, as shown in Examples 1 to 4, hereinbelow. Examples of suitable diols include ethylene glycol, 1,3-propanediol, 1,4-butanediol, 1,5-pentanediol, 1,6-hexanediol, 1,8-octanediol, 1,10-decanediol, 1,12-dodecanediol, 1-16-hexadecanediol, and 1,18-octadecanediol. Such diols are available from commercial sources.

Fluorinated piperazines according to general formula II can be prepared using known organic reactions such as, for example, those disclosed in U.S. Pat. No. 5,451,622 (Boardman et al.). An exemplary method of preparation is by the reaction of fluoroaliphatic sulfonyl fluorides, R_{f}SO₂F, with piperazine.

The fluorinated melt additives can be combined with an extrudable polymer and extruded to form a release liner (e.g., as a film). Typically, the amount of melt additive co-extruded with the extrudable polymer is an amount of from 0.01 to 5 weight percent, preferably 0.1 to 3 weight percent, and more preferably 0.3 to 1.5 weight percent, based on the total weight of the extruded release liner, however other amounts may also be used.

Advantageously, melt additive compounds according to the present disclosure may still be receptive to dyes (e.g., textile dyes), while displaying a reasonable degree of water and oil repellency. Accordingly, melt additive compounds according to the present disclosure may be suitable for textile applications including carpet and woven, nonwoven or knit fabrics, for example.

Examples of extrudable polymers include thermoplastic polymers (preferably non-fluorinated) such as polyesters (e.g., polyethylene terephthalate, polybutylene terephthalate, and polycaprolactone), cellulosics (e.g., cellulose acetate and cellulose butyrate), polyamides (e.g., Nylon 6 and Nylon 6,6), polyimides, polyolefins (e.g., polyethylenes, polypropylenes, and polybutylenes), polyetherketone (PEK), polyetheretherketone (PEEK), polycarbonates, and polyacrylics (e.g., polyacrylonitrile and polymethyl methacrylate), and combinations thereof.

Extruded release liners may contain other ingredients such as for example, fillers, antioxidants, conductive materials, fillers, lubricants, pigments, plasticizers, processing aids, and UV-light stabilizers.

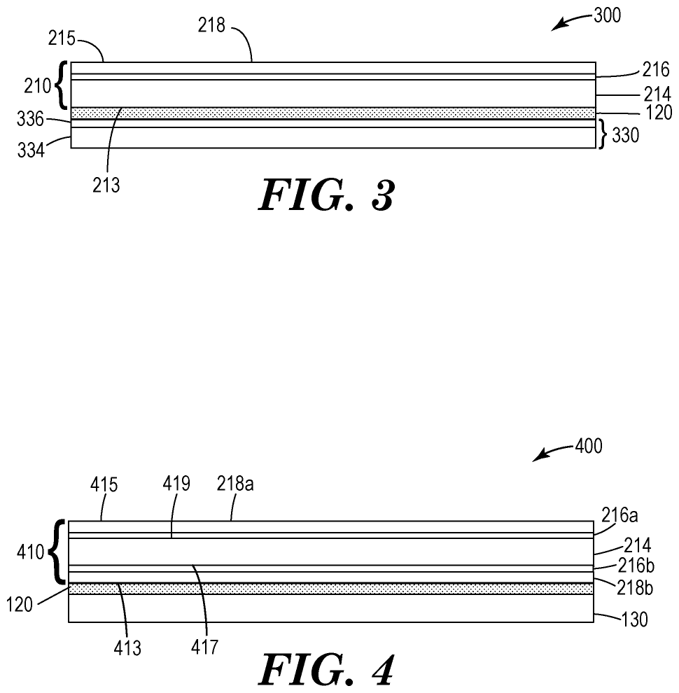

In some embodiments, the release liner can be a composite liner. Referring now to FIG. 3, composite adhesive fire barrier 300 comprises fire barrier material 210 having first and second opposed major surfaces (213, 215). Fire barrier material 210 comprises insulating paper 214 comprising inorganic fibers. Woven glass fabric 218 is secured to insulating paper 214 by bonding adhesive 216. Pressure-sensitive adhesive layer 120 is disposed on first major surface 213 of fire barrier material 210, and composite release liner 330 releasably adhered to pressure-sensitive adhesive layer 120. Composite release liner 330 comprises perfluoropolyether 336 disposed on backin 334.

Suitable composite release liners 330 can be prepared by coating a backing with a perfluoropolyether or a polymerizable precursor thereof followed by polymerization to form a perfluoropolyether. Coating may be out of solvent or in pure form, any suitable coating technique can be used including, for example, roll coating, knife coating, curtain coating, gravure coating, or spraying.

As used herein, the term “perfluoropolyether” refers to any compound that includes a perfluoropolyether segment. Exemplary perfluoropolyethers have divalent segments represented by to following formula:

—CF₂O(CF₂CF₂O)ₘ(CF₂O)ₙCF₂—

where m and n denote randomly distributed repeating units and the ratio m/n is 0.2:1 to 5:1, and each segment has a number average molecular weight of 800 to 10,000 grams/mole.

Any dimensionally stable backing, preferably in sheet, strip, or continuous form may be used. Suitable backings include, for example, paper, polyester, polyvinyl chloride, polypropylene, cellulose acetate. Exemplary suitable release liners having a layer of perfluoropolyether disposed on a backing are described in U.S. Pat. No. 4,472,480 (Olson), the disclosure of which is incorporated herein by reference.

In some embodiments, the Referring now to FIG. 4, composite adhesive fire barrier 400 comprises fire barrier material 410 (i.e., a composite fire barrier material) having first and second opposed major surfaces (413, 415). Fire barrier material 410 comprises insulating paper 214 comprising inorganic fibers. Woven glass fabrics 218a, 218b are secured to first and second opposed major surfaces (417, 419) of insulating paper 214 by bonding adhesive 216a, 216b. Pressure-sensitive adhesive layer 120 is disposed on first major surface 213 of fire barrier material 210, and release liner 130 releasably adhered to pressure-sensitive adhesive layer 120.

Composite adhesive fire barriers according to the present disclosure are useful as thermal runaway/fire barriers in electrical battery packs, especially those based on lithium cells. In typical use, the composite adhesive fire barrier is adhered between cells and/or between cells and the housing of the battery pack during its manufacture (i.e., assembly).

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight. Table 1, below, reports abbreviations and materials used in the examples.

TABLE 1

| ABBREVIATION | DESCRIPTION AND SOURCE |
|---|---|
| AK1000K | a linear, non-reactive polydimethylsiloxane with a kinematic viscosity of |
| | approximately 1000000 mm²/sec (, obtained under the trade designation |
| | WACKER AK 1000K from Wacker, Adrian, Missouri |
| TMS803 | co-hydrolysis product of tetraalkoxysilane (Q unit) and |
| | trimethylethoxysilane (M unit), obtained under the trade designation |
| | BELSIL TMS 803 from Wacker |
| 468MP | Adhesive transfer tape obtained under the trade designation 3M 468MP |
| | from 3M Company, St. Paul, Minnesota |
| CeQUIN | 20 mil thick inorganic insulating paper comprising primarily of glass |
| | fibers and microfibers, inorganic filters, and less than 10% organic |
| | binders, obtained under the trade designation 3M CeQUIN I from 3M |
| | Company |
| L1 | polyester film release liner having a perfluorinated additive |
| SC2025 | Glass (E-glass) fabric with a calcium silicate finish, commercially |
| | available from HKO Isolier-und Textiltechnik GmbH, Oberhausen, |
| | Germany |
| SE1 | CeQUIN laminated to the SC2025 using a 42.7 wt. % sodium silicate |
| | solution in water (inorganic adhesive) and dried in an oven |

### Test Methods

### Torch Flame Test

A 50.8 mm×50.8 mm sample of tape was laminated to one end of an anodized aluminum plate,

The plate with the material was run through a laminator at 50 kPa, 180° F. (82.2° C.) at 16 feet/minute (4.6 m/min). The anodized aluminum plate was then hung vertically by using a binder clip at the end opposite of the sample. A BernzOmatic 370A UL listed LP gas torch for use with a TX-9 container was used to apply a flame to the center of the tape sample. The flame was applied up to 5 minutes. If the sample fell prior to the 5 minutes the test was stopped. A pass was given to samples that did not fall off the aluminum plate for 5 minutes. If the sample fell, the time was recorded.

### T-Peel Adhesion Test

General guidelines of ASTM D1876-08(2015)el “Standard Test Method for Peel Resistance of Adhesives (T-Peel Test)” were used. Pressure-sensitive adhesive strips with release liner, 12.7 mm wide×150 mm long strips of tape, were cut using a razor blade. The release liner was removed and manually laminated to in the center of a 5 mil (127 microns) thick 15.9 mm (5/8 in) wide by 200 mm long anodized aluminum foil. The samples were run through a laminator at 50 kPa, 200° F. (93.3° C.) at 16 feet/minute (4.6 m/min) with 3 strips at one time. A specified ambient dwell was given prior to pulling at a rate of 300 mm/min in a tensiometer. Break load and extension at break were recorded.

### Dynamic SHEAR TEST

General guidelines of ASTM D1002-10(2019) “Standard Test Method for Apparent Shear Strength of Single-Lap-Joint Adhesively Bonded Metal Specimens by Tension Loading (Metal-to-Metal)” were used. Pressure-sensitive adhesive strips with release liner, 12.7 mm wide×75 mm long strips were cut, the release liner was removed, and a 12.7 mm of the 75 mm (12.7 mm by 12.7 mm overlap) portion of the strip was laminated to an anodized aluminum plate. The plate with the strip was run through a laminator at 50 kPa, 180° F. (82.2° C.) at 16 feet/minute (4.6 m/min) with 2 strips at one time. A 20 minute dwell was given prior to pulling at a rate of 300 mm/min in a tensiometer. Break load and extension at break were recorded.

### Comparative Example CE-A

468 MP was manually laminated to the CeQUIN side of SE1 using a laminator with a top metal roll at 180° F. (82.2° C.) at 16 ft feet/minute (4.6 m/min) using 50 kPa applied pressure.

### examples EX-1 TO EX-9

Silicone adhesive precursor was compounded in a twin-screw extruder by feeding appropriate amounts of AK1000K silicone and TMS803 MQ silicate tackifying resin into the extruder as reported in

Table 2. The mixture of AK1000K and TMS803 was extruded onto the SE1 using a rotary rod die, either on the CeQUIN side or the SC2025 side as described below. Next, the silicone adhesive precursor was e-beam crosslinked in-line with a 220 keV and the designated dosage (Mrads) in Table 2 and then releasably adhered to an L1 release liner a laminator and wound into a roll.

It was observed that the L1 release liner was cleanly removed from the crosslinked silicone pressure-sensitive adhesive without leaving residue on the release liner surface or disrupting adhesive or underneath CeQUIN paper. For CE-A, the adhesive tape was laminated to the CeQUIN surface without further processing.

Table 2 reports silicone pressure-sensitive adhesives used in Examples EX1-EX10 and Comparative Example CE-A.

Table 3 reports performance testing of Examples EX1-EX10 and Comparative Example CE-A.

TABLE 2

| | SILICONE | | | | | | |
|---|---|---|---|---|---|---|---|
| | PRESSURE- | ADHESIVE | | | | | |
| USED IN | SENSITIVE | WT. | | | | | SURFACE |
| EXAMPLE | ADHESIVE | RATIO | COMPOUNDED | THICKNESS | | MRADS | COATED |
| CE-A | 468MP | — | — | — | | — | CeQUIN |
| EX-1 | AK1000K/TMS803 | 80/20 | Offline | 4.5 | mil | 6 | CeQUIN |
| EX-2 | AK1000K/TMS803 | 80/20 | Offline | 4.5 | mil | 4 | CeQUIN |
| EX-3 | AK1000K/TMS803 | 80/20 | Offline | 4.5 | mil | 2 | CeQUIN |
| EX-4 | AK1000K/TMS803 | 80/20 | Offline | 4.5 | mil | 6 | Glass |
| EX-5 | AK1000K/TMS803 | 80/20 | Offline | 4.5 | mil | 4 | Glass |
| EX-6 | AK1000K/TMS803 | 80/20 | Offline | 4.5 | mil | 2 | Glass |
| EX-7 | AK1000K/TMS803 | 80/20 | Offline | 1.7 | mil | 6 | CeQUIN |
| EX-8 | AK1000K/TMS803 | 80/20 | Offline | 1.7 | mil | 4 | CeQUIN |
| EX-9 | AK1000K/TMS803 | 80/20 | Offline | 1.7 | mil | 2 | CeQUIN |
| EX-10 | AK1000K/TMS803 | 80/20 | Inline | 3 | mil | 4 | CeQUIN |

TABLE 3

| | | T-PEEL ADHESION TO | | | |
|---|---|---|---|---|---|
| | | ANODIZED ALUMINUM | | DYNAMIC SHEAR | |
| | | FOIL | | ADHESION TO ANODIZED | |
| | | BREAK LOAD | | ALUMINUM PLATE | |
| | TORCH | grams/inch (g/cm) | | BREAK | EXTENSION |
| | FLAME | 30 MINUTES | 96 HOUR | LOAD, | AT BREAK, |
| EXAMPLES | TEST | DWELL | DWELL | grams | mm |
| CE-A | Failed at 1.3 min | 193.2 (76.06) | 154.6 (60.87) | 1297 | 1.15 |
| EX-1 | Passed | 237.4 (93.46) | 310.0 (122.1) | 5875 | 2.05 |
| EX-2 | Passed | 305.3 (120.2) | 243.6 (95.91) | 4146 | 2.2 |
| EX-3 | Passed | 168.8 (66.46) | 128.2 (50.47) | 3218 | 1.7 |
| EX-4 | Passed | 243.0 (95.67) | 187.9 (73.98) | 245 | 0.65 |
| EX-5 | Passed | 278.3 (109.6) | 285.6 (112.4) | 2056 | 1.7 |
| EX-6 | Passed | 292.5 (115.2) | 319 (125.6) | 1469 | 2.15 |
| EX-7 | Passed | 221.4 (87.17) | 243.5 (95.87) | 4069 | 0.7 |
| EX-8 | Passed | 202.2 (79.61) | 221.2 (87.09) | 4998 | 0.9 |
| EX-9 | Failed at 1.3 min | 190.8 (75.12) | 228.1 (89.80) | 2928 | 1.05 |

All cited references, patents, and patent applications in this application that are incorporated by reference, are incorporated in a consistent manner. In the event of inconsistencies or contradictions between portions of the incorporated references and this application, the information in this application shall control. The preceding description, given in order to enable one of ordinary skill in the art to practice the claimed disclosure, is not to be construed as limiting the scope of the disclosure, which is defined by the claims and all equivalents thereto.

1. A composite adhesive fire barrier comprising:
a fire barrier material having first and second opposed major surfaces, the fire barrier material comprising inorganic fibers and having an inorganic component content of at least 50 percent by weight;
a pressure-sensitive adhesive layer disposed on the first major surface of the fire barrier material, wherein the pressure-sensitive adhesive layer comprises a crosslinked mixture of a silicone having a kinematic viscosity of at least 30,000 centistokes and an MQ silicate tackifying resin disposed on the fire barrier material, wherein the silicone and the MQ silicate tackifying resin are present in a respective weight ratio of 1:2 to 20:1; and
a release liner comprising a fluorinated compound, wherein the release liner is free of silicone moieties, and wherein the pressure-sensitive adhesive layer is releasably adhered to the release liner.

2. The composite adhesive fire barrier of claim 1, wherein the fire barrier material comprises an intumescent material.

3. The composite adhesive fire barrier of claim 1, wherein the fire barrier material comprises an insulating paper comprising inorganic fibers and a first woven inorganic fabric secured to the insulating paper comprising inorganic fibers by a first bonding adhesive.

4. The composite adhesive fire barrier of claim 3, wherein the fire barrier material further comprises a second woven inorganic fabric secured to the insulating paper by a second bonding adhesive, and wherein the first and second bonding adhesives are respectively disposed on the first and second opposed major surfaces of the insulating paper.

5. The composite adhesive fire barrier of claim 1, wherein at least one of the first or second woven glass fabric comprises a woven inorganic fabric.

6. The composite adhesive fire barrier of claim 3, wherein at least one of the first or second adhesives comprises an alkali metal silicate.

7. The composite adhesive fire barrier of claim 1, wherein the pressure-sensitive adhesive layer is substantially free of catalysts, crosslinking agents, and volatile organic solvent.

8. The composite adhesive fire barrier of claim 1, wherein the release liner comprises a perfluoropolyether disposed on a backing.

9. The composite adhesive fire barrier of claim 1, wherein the release liner comprises a mixture of a nonfluorinated thermoplastic polymer and a fluorinated melt additive.

10. A method of making a composite adhesive fire barrier, the method comprising:
providing a fire barrier material having first and second opposed major surfaces, the fire barrier material comprising inorganic fibers and having an inorganic component content of at least 50 percent by weight;
extruding a mixture onto the first major surface of the fire barrier material, wherein the mixture comprises a silicone having a kinematic viscosity of at least 30,000 centistokes and an MQ silicate tackifying resin disposed on the fire barrier material, wherein the silicone and the MQ silicate tackifying resin are present in a respective weight ratio of 1: 2 to 20:1;
crosslinking the mixture by exposing it to electron beam radiation to provide a pressure-sensitive adhesive layer; and
releasably adhering a release liner to the pressure-sensitive adhesive layer, wherein the release liner comprises a fluorinated compound, and wherein the release liner is free of silicone moieties.

11. The method of claim 10, wherein the fire barrier material comprises an intumescent material.

12. The method of claim 10, wherein the fire barrier material comprises an insulating paper comprising inorganic fibers and a first woven inorganic fabric secured to the insulating paper comprising inorganic fibers by a first bonding adhesive.

13. The method of claim 12, wherein the fire barrier material further comprises a second woven inorganic fabric secured to the insulating paper by a second bonding adhesive, and wherein the first and second bonding adhesives are respectively disposed on the first and second opposed major surfaces of the insulating paper.

14. The method of claim 12, wherein at least one of the first or second woven inorganic fabric comprises a woven inorganic fabric.

15. The method of claim 12, wherein at least one of the first or second adhesives comprises an alkali metal silicate.

16. The method of claim 10, wherein the pressure-sensitive adhesive layer is substantially free of catalysts, crosslinking agents, and volatile organic solvent.

17. The method of claim 1, wherein the release liner comprises a perfluoropolyether disposed on a backing.

18. A method of using a composite adhesive fire barrier according to claim 1, the method comprising:
separating the release liner from the pressure-sensitive adhesive layer; and
adhering the pressure-sensitive adhesive layer to at least one component of an electrical battery pack.

19. The method of claim 18, wherein said adhering the pressure-sensitive adhesive layer to the at least one component of the electrical battery pack occurs before or during assembly of the electrical battery pack.
